(19) United States
(12) Patent Application Publication
(10) Pub. No.: US 2010/0080951 A1
(43) Pub. Date: Apr. 1, 2010

(54) STRUCTURED SURFACE WITH ADJUSTABLE ADHESION

(75) Inventors: Aránzazu Del Campo Bècares, Mannheim (DE); Eduard Arzt, Stuttgart (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Max-Planck-Gesellschaft zur Forderung der Wissenschaften e.V., a corporation of Germany, Munchen (DE)

(21) Appl. No.: 12/446,990

(22) PCT Filed: Oct. 10, 2007
(86) PCT No.: PCT/EP2007/008820

§ 371 Date: Oct. 7, 2009

(30) Foreign Application Priority Data
Oct. 25, 2006 (DE) 10 2006 050 365.1

(51) Int. Cl. B32B 3/06; B29C 71/04

(52) U.S. Cl. 428/99; 264/340; 264/446

(57) ABSTRACT

A structured surface of a solid body comprises a multiplicity of projections, which form a contact area which can become attached to adjacent surroundings, and a carrier layer, on which the projections are arranged, wherein properties of the projections and/or of the carrier layer are specifically variable in such a way that the attachability of the contact area is adjustable. A component which is provided with such a structured surface and a method for modifying the structured surface are also described.

### RELATED APPLICATION

This is a §371 of International Application No. PCT/EP2007/008820, with an international filing date of Oct. 10, 2007 (WO 2008/049517 A1, published May 2, 2008), which is based on German Patent Application No. 10 2006 050 365.1 filed Oct. 25, 2006.

This disclosure relates to a structured surface of a solid body, which comprises a multiplicity of projections, which form a contact area with a predefined adhesion.

This disclosure also relates to a component provided with such a structured surface, and to a method for modifying the structured surface.

### BACKGROUND

It is known that various animals, such as e.g. insects or lizards, have the capability of stopping or moving on surfaces oriented in any given manner. This capability is achieved by a fine structure on the feet of the animals. The fine structure causes relatively large attachment forces between the feet surfaces and an adjacent surface, which may exceed the weight force of the animal.

In a manner similar to the generation of attachment forces in nature, it is known to structure solid body surfaces in order to increase the adhesion thereof. WO 03/099951 A2 describes a method for modifying the surface of an object, in which there is formed on the surface of the object a multiplicity of projections, the free end faces of which form a contact area. The contact area is characterized by an increased adhesion compared to the unstructured surface.

For the practical use of structured surfaces with increased adhesion, it is of interest to vary the adhesion as a function of the current requirements of a specific application. By way of example, a tool with an attachment element is to be used first to grip a workpiece at a first position, then to move the workpiece to a second position and finally to release the workpiece at the second position. Until now, in order to overcome the attachment forces of the structured surface, it has been necessary to exert additional mechanical forces e.g. on the attachment element or on the workpiece, under the effect of which the structured surface is lifted away from the adjacent object. However, the exertion of additional separating forces represents an additional effort which is usually undesirable. Furthermore, the structured surface or the adjacent object may be disadvantageously affected, e.g. damaged, by the separating forces.

It could therefore be helpful to provide an improved structured surface, by means of which the disadvantages of the conventional structured surfaces are overcome. It could also be helpful to provide a component equipped with such an improved structured surface, and to propose an improved method for modifying the surface.

### SUMMARY

A first aspect is achieved by the general technical teaching of providing a structured surface which comprises a carrier layer and a multiplicity of projections, and the properties thereof are specifically variable in such a way that a predefined adhesion in relation to adjacent surroundings can be set for a contact area formed by the projections. The projections of the structured surface are formed of a variable material. Advantageously, therefore, the adhesion of the contact area can be adjusted directly by varying the material per se and/or its outer shape. Variants are also encompassed in which the projections and the carrier layer or exclusively the carrier layer are formed of the variable material. The adjustment of the adhesion by varying the carrier layer may be advantageous for certain uses of the structured surface, ambient conditions or materials used.

The variable properties (material properties, substance properties) of the material used include physical (including geometric) and/or chemical properties of the material per se and/or its outer shape. The properties are specifically variable, that is to say can be varied in a targeted manner through a physical and/or chemical effect. When varying a property of the projections and/or of the carrier layer, the latter are converted (switched) from a first physically and/or chemically defined state to a second, varied state. The variability of the properties is also referred to as a switchability.

The contact area which is formed by the free ends of the projections of the structured surface and which is accordingly interrupted by the distances between the free ends has an adhesion which is adjustable by the targeted switching of the properties of the projections and/or carrier layer. The term “adhesion” refers to the strength of the molecular interaction forces that can be formed by the contact area in relation to adjacent surroundings, in particular an adjacent solid body or an adjacent liquid. By virtue of the adhesion (attachability), it is possible to determine the counter-forces to mechanical forces which are applied for the relative movement of the contact area and an adjacent object. The attachment comprises counter-forces with components perpendicular and/or parallel to the surface of the contact area. Accordingly, the term “adhesion” in the context of the present description includes both the adhesion capability and also the ability to generate friction force.

The structured surface has the advantage that, by switching the material property of the projections and/or of the carrier layer, the adhesion of the contact area can be switched from a state of high adhesion to a state of low adhesion (or vice versa). Accordingly, the adhesion of the contact area can be varied as a function of a specific requirement, such as e.g. to pick up a workpiece or to deposit a workpiece, without external mechanical separating forces having to be exerted on the structured surface or the workpiece. The field of application of structured surfaces is thus considerably widened, with previous uses for structured surfaces being considerably simplified since there is no need to make provisions for exerting separating forces.

According to a further aspect, the general technical teaching of providing a component with adjustable adhesion is provided, which has the structured surface according to the first aspect. Advantageously, the carrier layer of the structured surface may form part of the component, that is to say the projections of the structured surface may be formed directly from the material of a base body of the component. Alternatively, the structured surface may be arranged in layer form on a base body of the component. Advantageously, therefore, an existing object can be retrofitted with the structured surface in order to provide the object with an adjustable adhesion.

According to a further aspect, the general technical teaching is provided of modifying a structured surface by specifically varying properties of projections and/or of a carrier layer of the surface in order to set a predefined adhesion of a contact area formed by the projections. By virtue of a predefined external effect, physical (including geometric) and/or chemical properties of the projections and/or of the carrier layer are varied. Unlike conventional structured surfaces, in which an attachment or detachment is brought about by an external mechanical force acting on the attached object or on the component comprising the structured surface, in the method the structured surface per se is influenced directly.

The structured surface comprises a multiplicity of projections which form the contact area of the surface. The term “projection” refers to elongate structures, e.g. with a rod or filament shape, which stand on the carrier layer. Depending on the method for producing the structured surface, the carrier layer and the projections may be made from a common material or from different materials. The projections form a microstructured or nanostructured topography, i.e. the projections typically have an axial length in the range from 10 nm to several mm, e.g. 5 mm, and a radial dimension in the range of a few nm, e.g. 2 nm, to 1 mm. The projections form a fiber arrangement, the adhesion of which can be adjusted from an adherent state to a non-adherent state (or vice versa) by an external influence which causes a variation in particular of geometric, mechanical or chemical properties of the fiber arrangement.

All the projections may have the same shape and size. Alternatively, the projections may have a hierarchical size distribution, e.g. as described in WO 03/099951 A2, property gradients and/or property anisotropies. A property gradient comprises e.g. a gradient in the Young's modulus, by means of which the projections have a greater hardness next to the carrier layer than in their head parts. A property anisotropy is obtained e.g. if the projections have different Young's moduli in the longitudinal and transverse directions.

We have found that many different material properties are advantageously suitable for adjusting the adhesion, and appropriate materials which can be specifically varied are available. A first group of specifically variable properties includes physical properties, in particular mechanical and/or geometric properties of the projections and/or of the carrier layer.

The projections may comprise materials having a variable angle of inclination with respect to the carrier layer. The angle of inclination advantageously represents a simple geometric parameter of the projections, by means of which the adhesion can be directly varied. It may for example be provided that all the projections have the same angle of inclination, which is variable between a first value (state of increased adhesion) and a second value (state of reduced adhesion compared to the first state). Alternatively, it may be provided that the projections have the same angle of inclination only in the state of increased adhesion, but have different angles of inclination in the state of reduced adhesion. In this case, the adhesion of the structured surface is adjusted by varying the distribution of angles of inclination of the projections. This variant of the invention has advantages in particular for a gradual adjustment of the adhesion as a function of the width of the distribution of angles of inclination. Varying the distribution of angles of inclination may lead to a completely unordered state of the projections (so-called collapse of the structured surface). A reversible collapse of the structured surface may be provided.

The setting of the adhesion as a function of the angle of inclination may be selected in any specific use situation, e.g. by means of tests. The adhesion typically increases as the angle of inclination decreases. As an alternative, a reduced adhesion may be set as the angle of inclination is reduced, e.g. if the projections are particularly soft at a reduced angle of inclination.

A variation of the distances between the projections may be provided, in particular between the head parts thereof which directly form the contact area. For this variant, available shrinkable or swellable materials may be used for example to form the projections and/or the carrier layer. The use of a shrinkable or swellable carrier layer has the advantage that a significant change in the distances between the projections can be achieved by a relatively small external effect, such as e.g. a change in temperature or a change in relative humidity. The adhesion of the contact area can be set with particularly high sensitivity. If an adjustment of the modulus of elasticity of the projections and/or of the directional dependence thereof is provided, the adhesion of the contact area can advantageously be varied without changing the optical properties thereof, such as e.g. the visual appearance.

In further variants, a specific varying of chemical properties of the projections and/or of the carrier layer may be provided. We have found that organic materials (in particular polymer materials), composite materials or metals are available in which, by means of an external effect, the molecular structure, solid body structure (in particular polymer structure) and/or chemical composition can be specifically varied in such a way as to vary the capability of the projections for molecular interactions with respect to directly adjacent objects, particularly the surface adsorption.

Another aspect lies in the fact that there are a large number of different external effects which can be used to modify the structured surface and to adjust the adhesion. One external effect may comprise e.g. a change in temperature by means of heating or cooling. A heating may be achieved by means of a heating device which acts from outside, e.g. by means of thermal radiation, or from inside, e.g. by means of induction heating. As an alternative or in addition, static or dynamic magnetic and/or electric fields or electromagnetic radiation can be used as the external effect. This variant has advantages in particular in applications in which the structured surface, a component equipped therewith or an object adjacent thereto is temperature-sensitive. Furthermore, magnetic and/or electric fields may be used for a reversible adjustment of the adhesion. Finally, the external effect may comprise acting on the structured surface with at least one chemical substance. In this case, an unintentional adjustment of the attachment, e.g. due to interference fields, can be avoided.

The projections and/or the carrier layer of the structured surface in certain examples have a modulus of elasticity of preferably less than 10 GPa. This can provide easy adaptability of the structured surface to smooth or rough surfaces of an adjacent object attached to the contact area. The contact area can thus be shaped in the attachable state to match the surface of the adjacent object. Organic polymer materials, for example, have a sufficiently low modulus of elasticity. Alternatively, the projections and/or the carrier layer may be formed of a metal. Use may be made in particular of metals (so-called shape memory metals, e.g. nickel-titanium, see Y. Zhang et al. in “Appl. Phys. Lett.” vol. 89, 2006, page 041912).

If the projections exhibit a hardness gradient, the modulus of elasticity next to the carrier layer is e.g. 10 GPa and at the head parts is e.g. 1 GPa. If the projections have anisotropic Young's moduli, the Young's modulus in the longitudinal direction of the projections is e.g. 1 GPa and in the transverse direction is e.g. 10 MPa.

According to a further alternative, the projections of the structured surface may be formed of a material with a higher modulus of elasticity, e.g. a ceramic or a semiconductor material, if the structured surface is intended to attach to objects with smooth surfaces or if the carrier layer is formed with a modulus of elasticity of less than 10 GPa. In the latter case, an attachment to smooth or rough surfaces can be achieved even when the projections are formed of a harder material.

If the projections and/or the carrier layer are formed of a polymer material, further aspects may result from the large number of available polymers and the capability thereof to adapt to specific requirements of a use of the structured surface. In particular, use may be made of a uniform (homogeneous) polymer material a polymer composition composed of various polymers or a polymer composite composed of at least one polymer material and one foreign material, such as e.g. metal particles. Polymer composites have the further aspect that suitable compositions of available polymers which are suitable for producing structured surfaces (for methods, see e.g. WO 03/099951 A2) can be provided with metallic or magnetic additives in order to achieve the adjustability of the adhesion.

In particular, shape memory polymers, liquid crystal polymers, composites containing metallic, non-magnetic or magnetic particles, radiation-sensitive polymers and liquid-sensitive polymers have proven to be suitable as polymer materials. The polymer materials are formed e.g. of elastomers or block copolymers. Shape memory polymers are polymers which exhibit the shape memory effect (see e.g. A. Lendlein et al. in “Angewandte Chemie—International Edition”, vol. 41, 2002, pages 2034-2057, R. Mohr et al. in “PNAS”, vol. 103, 2006, pages 3540-3545). Liquid crystal polymers (see e.g. K. Hiraoka et al. in “Macromolecules”, vol. 38, 2005, pages 7352-7357) can be used to adjust the adhesion under the effect of electric fields. Radiation-sensitive polymers include in particular light-sensitive polymers which change their shape or structure when irradiated with light (IR, VIS or UV) (see A. Lendlein et al. in “Nature”, vol. 434, 2005, pages 879-882). Polymer materials which are used may belong to several of the aforementioned groups.

If the properties of the projections and/or of the carrier layer can be varied reversibly and repeatedly according to one aspect, the adhesion of the structured surface can be switched repeatedly between a state of increased adhesion and a state of reduced adhesion. In this case, particular aspects are obtained for use of the structured surface in dynamic processes, in which the adhesion is to be adapted in each case to specific requirements of a method. Alternatively, a one-off, irreversible setting of the adhesion may be provided. A one-off variation of the projections and/or of the carrier layer means that the adhesion of the structured surface is subsequently set after it has been produced, preferably just before use.

A further aspect lies in the fact that the projections may have at their free ends (head parts) one or more shapes which may be different depending on the specific use of the structured surface. By way of example, end faces with a planar, spherical, curved or flattened shape or hollow or cupped structures, such as tubes, suction cups or shapes split into sub-structures, may be provided.

Examples of uses lie in the fields of transport technology, particularly in tool technology and robot technology, in construction technology, in textile technology, particularly in the formation of textile closures, in medical technology, particularly for medical devices or medical material, such as e.g. dressing material, for sports equipment, such as e.g. sports devices or sports shoes, or in household equipment technology, such as e.g. for furniture.

Further details and aspects will be described below with reference to the appended drawings.

### BRIEF DESCRIPTION OF DRAWINGS

FIGS. 1A and 1B show a first variant of structured surfaces with an illustration of the adjustment of the adhesion;

FIG. 2 shows schematic sectional views of projections of a structured surface;

FIGS. 3A to 7D show further variants of structured surfaces with an illustration of the adjustment of the adhesion; and

FIG. 8 shows a schematic illustration of a in transport technology.

### DETAILED DESCRIPTION

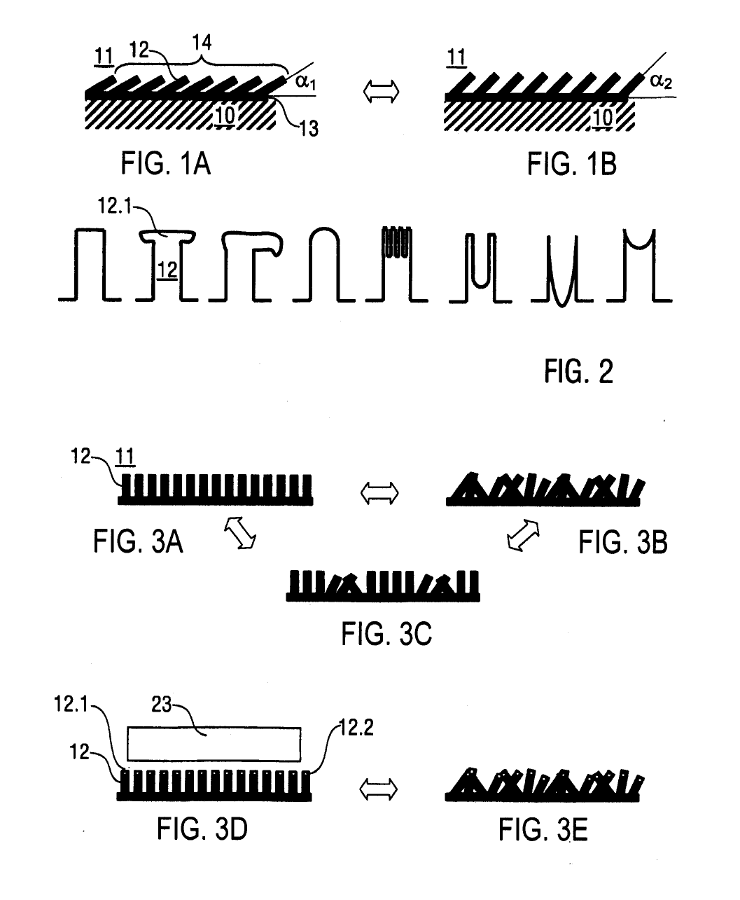

Various principles of action of the adjustment of the adhesion will be explained below by way of example with reference to FIGS. 1A to 7D. It is emphasized that the figures serve only to illustrate on a schematic basis. The implementation is not limited to the illustrated geometric shapes and size ratios of the structured surfaces which are shown as a detail on an enlarged scale, but rather the invention can be implemented accordingly with modified geometric ratios (see e.g. the description of FIG. 2, see also WO 03/099951 A1). In the figures, the structured surface is shown in each case with the carrier layer and the projections. In practical use (see e.g. FIG. 8), the structured surface is arranged on a base body or is provided as part of the latter. The base body may have a curved or flat surface shape. Accordingly, the structured surface may be curved or flat. For reasons of clarity, the base body is not shown in FIGS. 2 to 6B.

The following description will first explain embodiments of the specific, permanent or temporary variation of the structured surface. The materials and methods for producing the structured surface will then be described by way of example. It is emphasized that the various materials for implementing the different principles of action for the specific adjustment of the adhesion can be used as a function of the specific conditions of use of the structured surface. The described principles of action can be used to set a uniform adhesion on a surface or to form a gradient of the adhesion.

FIGS. 1A and 1B show a first embodiment of the structured surface 11 on a base body 10, which structured surface comprises a multiplicity of projections 12 on a carrier layer 13. The projections 12 form a regular arrangement at distances e.g. in the range from 10 nm to 1 mm. A contact area 14 is spanned by all of the free ends (head parts) of the projections 12. The contact area 14 is designed to form molecular interaction forces upon making contact with a surface of an adjacent object. Depending on the strength of all of the molecular interaction forces, an attachment bond to the adjacent object can be formed. The attachment bond is formed without any anchoring to the surface of the object or any meshing of projections, but rather is provided by van der Waals forces, optionally assisted by capillary and/or suction forces (see FIG. 2). Additional contributions may be made by electrostatic forces or capillary forces. FIG. 2 shows by way of example different variants of the projections 12 with head parts 12.1, which have e.g. a planar (in particular flat, spatula-shaped, T-shaped or L-shaped), curved (in particular spherical), hollow or split shape.

The projections 12 of the structured surface 11 may be produced by one of the following methods: micro- or nanolithography of the carrier layer, micro-printing, growth of the projections by self-organization, in particular of block copolymers, micro-spark erosion (in the case of metal materials), micro-EDM, surface machining by means of a focused ion beam, plastic forming, e.g. hot-stamping or injection molding and/or so-called rapid prototyping using laser beams (with powder or polymer materials). Since these methods are known per se, no further details regarding the methods will be described here. In order to produce the projections 12 from polymer material, for said methods use is made of polymer powder, polymer pellets or polymer precursor materials which optionally contain a crosslinking agent and/or a reinforcing agent. The crosslinking agent serves for crosslinking under the effect of chemical substances or under the effect of irradiation, so that the mechanical stability of the projections can be improved.

The molecular interaction forces formed by the contact area 14 may be set as a function of the angle of inclination a between a longitudinal direction of the projections 12 and the carrier layer 13. By way of example, a state of increased adhesion is obtained with polymer projections (material: PDMS, diameter: 10 μm, length: 50 μm) at a small angle of inclination α₁=30° (FIG. 1A), and a varied state of reduced adhesion compared to the first state is obtained at an angle of inclination α₂=45° (FIG. 1B). The adjustment of the adhesion as shown in FIGS. 1A and 1B may alternatively take place in such a way that a reduced adhesion is obtained at the small angle of inclination and an increased adhesion is obtained at the larger angle of inclination, or vice versa. The switching between the adherent and non-adherent state takes place by means of an external effect which is symbolized by the double arrow and comprises for example a temperature increase, electric fields, magnetic fields, electromagnetic radiation, in particular light, a mechanical influence (e.g. a pretension applied by a roller) or the effect of chemical substances (see FIGS. 5A to 6B).

As an alternative, by means of the external effect as shown in FIGS. 3A to 3C or 3D and 3E, the adhesion can be adjusted by specifically varying a state of order of the projections 12. The state of order of the projections 12 can be characterized by the width of distribution of the angles of inclination relative to the carrier layer 13. A state of increased adhesion is obtained only in a state in which the projections 13 form an arrangement with an ordered pattern (e.g. matrix pattern) and all point in the same direction.

In FIG. 3A, all the projections 12 have the same angle of inclination, i.e. the width of distribution of the angles of inclination is extremely small. By means of a specific physical and/or chemical effect, the angles of inclination of some (FIG. 3C) or all (FIG. 3B) projections 12 can be varied. The molecular interaction forces exerted by the totality of the projections 12 are reduced as the number of projections differing from the homogeneous orientation shown in FIG. 3A increases. Accordingly, the structured surface 11 can be switched by an external effect from the state of increased adhesion (FIG. 3A), possibly via an intermediate state (FIG. 3C), to a state of reduced adhesion (FIG. 3B).

As shown in FIGS. 3D and 3E, the state of order of the projections 12 can advantageously be adjusted by means of polymer composites containing magnetic particles. The magnetic particles 12.2 are arranged in or on the head parts 12.1 of the projections 12. Using the field of a magnet 23 (permanent magnet or switchable electromagnet), all the projections 12 are aligned so that the adherent state is set (FIG. 3D). By removing the magnet 23 or switching off the electromagnet, the magnetic field is eliminated so that the projections are oriented in a randomly distributed manner and the non-adherent state is set (FIG. 3E). The illustrated adjustment of the adhesion is advantageously repeatedly (reversible).

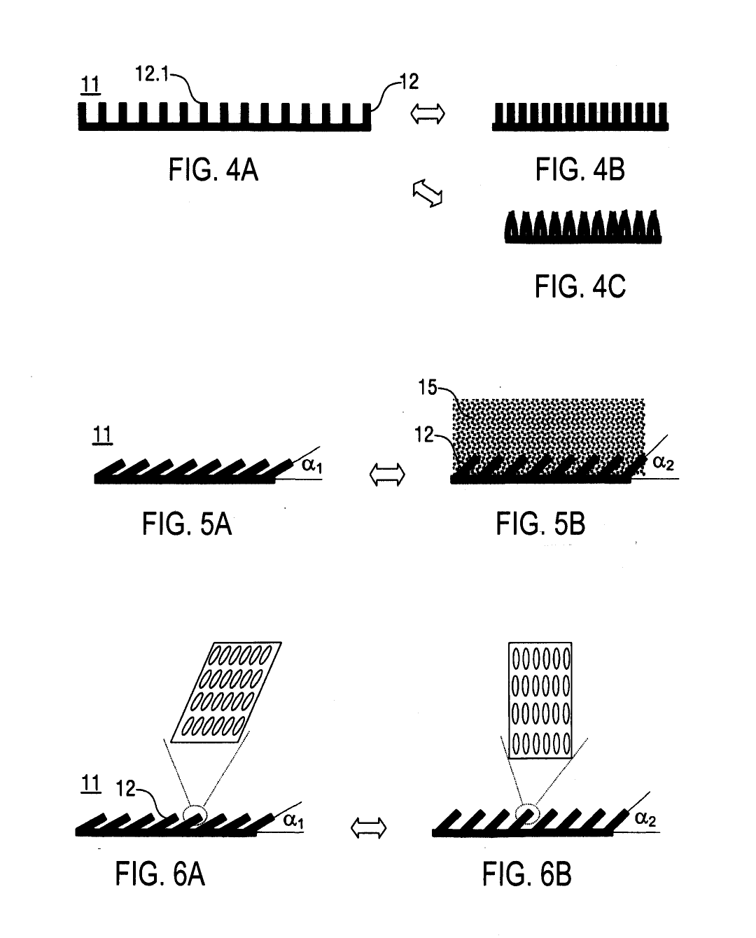

According to a further alternative, the distances between the head parts 12.1 of the projections 12 can be specifically varied in order to adjust the adhesion of the structured surface 11. By way of example, as shown in FIG. 4A, it may be provided that a low adhesion is obtained by relatively large distances between the head parts 12.1 (e.g. in the range from 100 nm to 1 mm). By means of an external effect, the number of head parts 12.1 and thus the microscopic contacts per unit area can be increased, so that, as shown in FIG. 4B, firstly a state of increased adhesion is achieved. Then, by the continued external effect, a lateral sticking-together of the projections 12 can be induced, so that the adhesion of the structured surface 11 is reduced (FIG. 4C).

The distances between the head parts 12.1 and thus the adhesion of the contact area 14 can be adjusted for example by heating the carrier layer 13. As the temperature is increased, the carrier layer shrinks, so that the distances between the head parts 12.1 are reduced. This is advantageously possible without the carrier layer becoming detached from a base body. As soon as the distance drops below a critical distance, the projections 12 stick to one another laterally (FIG. 4C), so that the adhesion is reduced or is varied until a repulsion effect is obtained. A carrier layer made from a shrinkable material is preferably used in embodiments in which the size of the component equipped with the structured surface changes during use, e.g. by expansion or contraction as a result of a change in temperature. With the adaptation of the carrier layer to the changed size, the adhesion of the surface can be adjusted at the same time.

To reduce the adhesion as shown in FIG. 4C, the projections are preferably formed of a polymer material with strong lateral adhesion, in particular of a soft elastomer, e.g. PDMS. Starting from the state of reduced adhesion, by cooling the structured surface it is possible to achieve a reduction in the lateral adhesion of the projections, so that the individual projections separate from one another (transition to the arrangement shown in FIG. 4B). In this state, an increased adhesion of the contact area 14 is set.

FIGS. 5A and 5B show the corresponding switch between a state of increased adhesion (FIG. 5A) and a state of reduced adhesion (FIG. 5B) by acting on the structured surface 11 with a chemical substance 15 in the form of a liquid or a gas or vapor, e.g. with water. Due to a relative humidity of the surrounding environment, water is adsorbed onto the projections 12, so that the adhesion varies as shown by virtue of a deformation of the projections, or alternatively or in addition by virtue of a chemical transformation in the material of the projections or on the surface thereof. Under the effect of the chemical surface 15, for example the angle of inclination of the projections 12 may remain constant but the adsorption capability of the surfaces thereof on the other hand may change.

In a manner analogous to FIGS. 1A and 1B, details regarding the adjustment of the adhesion using projections made from liquid crystal elastomers are illustrated in FIGS. 6A and 6B using the example of varying the angles of inclination of the projections 12. During a phase transition from an isotropic phase to a nematic or smectic phase, liquid crystal elastomers exhibit an extension or shrinkage along the mesogens in domain regions. The extension or shrinkage occurs spontaneously and rapidly during the phase transition, as shown in the schematically enlarged sub-diagrams of FIGS. 5A and 5B. The phase transition may be triggered by an external effect, which comprises for example a temperature change or an electric field. There is provided for example a change in temperature by a few degrees, e.g. +/−10° around the transition temperature at which the transition between the nematic and smectic phase or an isotropization takes place, or the formation of an electric field having a field strength of a few V/μm, e.g. 10 V/μm or 10⁷ V/m.

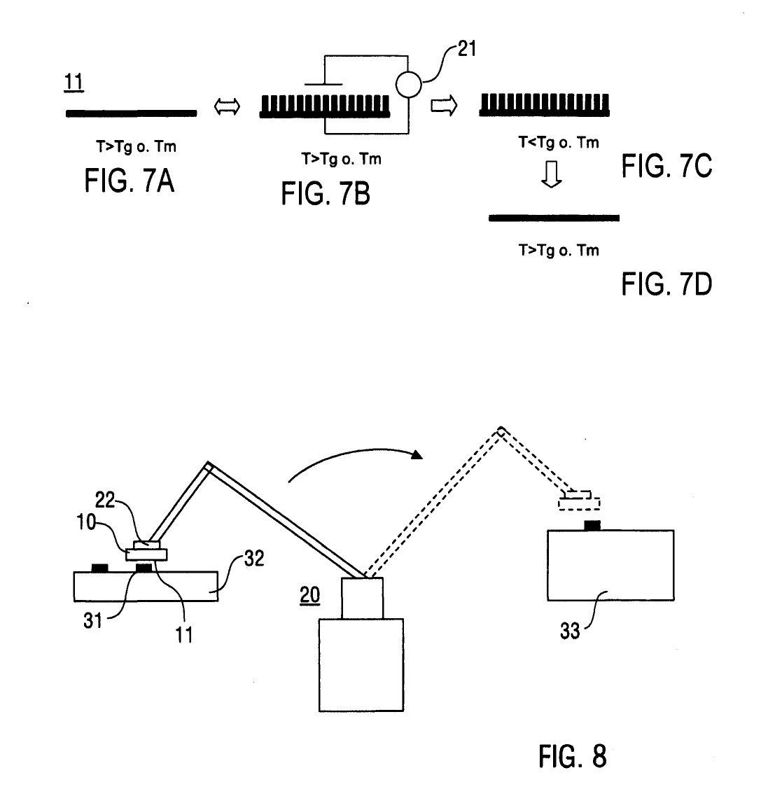

According to a further alternative, the adhesion of the structured surface 11 may be adjusted by means of a polymer material which is designed to form a structured surface in an external electric field. The process of electrically induced structuring is reversible, so that the adhesion can be switched between different states. As shown in FIGS. 7A to 7D, the switching of the structured surface under the effect of an electric field may be combined with a change in temperature in order to obtain properties of the projections even after the electric field has been switched off. By way of example, as shown in FIGS. 7A and 7B, the electrically induced transition from the state without adhesion (FIG. 7A) to the state with adhesion (FIG. 7B) takes place at a temperature above the glass transition temperature or the melting temperature of the polymer material. The electric field induced by an external voltage source 21 has for example a field strength of 10 V/cm. By cooling the structured surface 11 to below the glass transition temperature or melting temperature (FIG. 7C), the state with increased adhesion can initially be obtained even without the electric field. By heating the structured surface 11 to a temperature above the glass transition temperature or melting temperature, the adhesion can be adjusted to a reduced value (FIG. 7D). The embodiment shown in FIGS. 7A to 7D can be used with particular advantage in particular in transport technology, specifically in semiconductor technology and microelectronics.

In order to generate the electric field for the embodiments of the invention shown e.g. in FIGS. 1A, 1B, 3A to 3E or 7A to 7D, the voltage source 21 is connected to a lower electrode below the projections and to an upper electrode above the projections. The lower electrode is preferably formed by an electrically conductive part of the component which carries the structured surface, such as e.g. by an electrically conductive layer in an electronic component. The upper electrode is preferably formed by part of an additional tool, such as a transport tool as shown in FIG. 8. The position of the upper electrode determines the direction of the electric field to which the structured surface is exposed. Preferably, the two electrodes are of flat design and are arranged at a constant distance from, in particular parallel to, the structured surface.

Examples of materials which are suitable for forming structured surfaces will be described below.

1. Polymers with Shape Memory

In order to set the different degrees of adhesion of the structured surface and to induce the transitions between the different properties of the projections 12 and/or carrier layers 13, use may be made of polymers with shape memory. The projections are exposed to a mechanical stress for example at a temperature close to or above the glass transition temperature or the melting temperature, without exceeding the elasticity limit of the material. The pattern of the projections (e.g. FIG. 3B), which has collapsed under the mechanical stress, can be transformed into the original arrangement (e.g. FIG. 3A) for example by heating the material to above the glass transition temperature or melting temperature. Depending on the assignment of the permanent or transient state to one of the states of the polymer material, the following materials can be used to produce switchable structured surfaces:

1.1 Polymer Materials with a Crosslinked Permanent State and an Amorphous or Vitreous Transient State

Use may be made of linear or branched polymers, polymer compositions or polymer composites (e.g. based on polymethyl methacrylate (PMMA), polyvinyl chloride (PVC), polyurethane (PU), polynorbornene) with a physical crosslinking or entanglement which allows an elastic deformation. Particular preference is given to crosslinked elastomeric materials, since these allow a greater elastic deformation.

By way of example, an adhesive, regularly formed contact area (FIG. 3A) can be deformed by mechanical forces into the collapsed, non-adherent state (FIG. 3B) and cooled to a temperature below the glass transition temperature in order to fix the non-adherent state with the collapsed arrangement of the projections 12. In the case of an elastic deformation, the stress is released when the temperature is increased above the glass transition temperature and the collapsed arrangement will transform into the original ordered arrangement. Accordingly, the increased adhesion can be restored on the contact area as a result of the increase in temperature.

1.2 Polymer Materials with a Crosslinked Permanent State and a Semicrystalline Transient State

Use may be made of polymers, polymer compositions or polymer composites which have a capability for partial crystallization, such as for example trans-polyimide (PI), crosslinked polyethylene (PE) or thermoplastic elastomers.

By way of example, an ordered arrangement of the projections 12 as shown in FIG. 3A is formed with the crosslinked polymer. As a result of the crosslinking, the shape of the projections (state with increased adhesion) is stored in memory. In order to pass into the state with reduced adhesion (FIG. 3B), a mechanical (elastic) deformation is carried out at a temperature above the melting temperature of the crosslinked portion of the projections 12. For polymers such as e.g. crosslinked trans-PI or PE, the deformation is carried out a temperature of for example 80° C. The state with reduced adhesion is in this case the transient state which is fixed by the microcrystalline parts formed in the polymer during the cooling process. In order to set the increased adhesion (FIG. 3A), the structured surface is heated to a temperature above the melting temperature of the crosslinked portion of the polymer. The increase in temperature takes place below an upper limit at which there would be a risk of lateral collapse of the projections.

1.3 Mixed Polymer Compositions or Phase-Separated Block Copolymers with One Vitreous and One Semicrystalline Component

Use may be made of linear block copolymers, such as for example polystyrene-poly(1-butene) (PS-PB) or PU, with hard and soft components, or polyethylene terephthalate-poly(ethylene oxide) (PET-PEO), to form the projections 12. The permanent state (e.g. FIG. 3A) is stored by the vitreous state of one of the components (e.g. PS, or hard component of PU, or PET). The transient state (FIG. 3B) is achieved by a deformation at a temperature above the melting temperature of the second component and a subsequent cooling, so that the crystals fix a microcrystalline structure. The reduced adhesion is accordingly set. The melting temperature of the phase-separated block copolymers is for example in the range from 40° C. to 60° C. A supply of heat for the purpose of increasing the temperature causes a melting of the microcrystalline regions, so that the original state with increased adhesion (FIG. 3A) is set.

1.4 Mixed Polymer Compositions or Phase-Separated Block Copolymers with Two Vitreous Components

According to a further alternative, use may be made of block copolymers or polymer blends which contain two vitreous components to set different shapes of the projections and thus different degrees of adhesion. The projections 12 may be formed for example of PU with hard and soft components, such as for example methylene-bis(4-phenylisocyanate) or bisphenol A as the hard component and methylenic or oxymethylenic chains as the soft component. In this case, the permanent state (FIG. 3A) is stored by the vitreous state of one of the components (e.g. the hard component of PU). The transient state (FIG. 3B) is achieved by a deformation at a temperature above the glass transition temperature of the second component and a final cooling, so that the vitreous state of the second component is fixed. The glass transition temperature of the second component is for example in the range from 15° C. to 60° C. The increased adhesion is set by heating the structured surface above the glass transition temperature of the second (soft) component.

### 2. Liquid Crystal Elastomers

Use may be made of nematic or smectic liquid crystal elastomers to form the projections 12 of the structured surface 11 according to the invention. The adjustment of the adhesion when using this group of polymers is illustrated in FIG. 6 using the example of varying the angle of inclination of the projections 12. Examples of such polymers which have a biaxial shape memory are described for example by K. Hiraoka et al. in “Macromolecules”, vol. 38, 2005, pages 7352-7357.

### 3. Shrinkable and Swellable Polymer Materials

In order to adjust the adhesion of the structured surface 11 in the variant shown in FIGS. 4A and 4B, use may be made of a shrinkable and swellable polymer material, e.g. based on polyethylene, or a multilayer material, e.g. composed of biaxially oriented PE, PP, fluoropolymers or multiple layers of low-density PE. Suitable polymer materials are known for example from packaging technology.

4. Polymer Composites which Contain Metallic, Non-Magnetic Particles

If an adjustment of the adhesion by means of an increase in temperature is provided and the component equipped with the structured surface 11 or an adjacent object are not suitable for direct heating, use is made of polymer materials for example as mentioned in 1. to 3. which are loaded with metallic, non-magnetic particles. These polymer composites allow an inductive heating which is advantageously localized directly on the structured surface 11 and prevents damage to the component or the adjacent object. The inductive heating of polymer compositions is described for example by Mohr et al. in “PNAS”, vol. 103, 2006, pages 3540-3545.

### 5. Magnetic Polymer Materials

A further variant for adjusting the adhesion in particular in temperature-sensitive systems consists in using polymer composites containing magnetic particles or magnetic polymers or polymer compositions to form the projections. By way of example, use may be made of polymers containing added magnetic particles, e.g. of magnetite or metal oxide complexes, or, as an inherently magnetic polymer material, polyacetylene or compositions with alternating repeating units of polyenes and arenes which are coupled in the meta-position.

It may be provided for example that the polymer material with magnetic properties exhibits the permanent form with increased adhesion in the field-free state. In order to set a reduced adhesion, a magnetic field can be switched on, under the effect of which for example the angle of inclination of the projections 12 (FIGS. 1A and 1B) changes. As an alternative, the permanent state may be set under the effect of an existing magnetic field, wherein in this case, in order to adjust the adhesion, the existing magnetic field must be varied with regard to the intensity and/or direction.

According to a further alternative, the effect of the magnetic field may be coupled to a thermal transition, as described above in 1.1. In this case, the setting of the adhesion may be adjusted not only as a function of the strength and/or direction of the magnetic field but also as a function of the temperature of the projections.

In order to generate the magnetic field for the embodiments of the invention shown for example in FIGS. 1A, 1B, 3A to 3E or 7A to 7D, use is made for example of a permanent magnet as part of an additional tool, such as a transport tool as shown in FIG. 8.

### 6. Polar Polymer Materials

The projections 12 and/or the carrier layer 13 of the structured surface 11 may be formed of a polymer material which is designed for an alignment of polymer chains in reaction to an external electric field (polar polymer material). The polymer material contains e.g. dipoles which are able to align with one another in the external electric field. Using polar polymer materials, it is possible for example to implement the following variants.

6.1 Elastomer with Liquid Crystal Properties

Under the effect of an electric field, as illustrated by way of example in FIGS. 6A and 6B, liquid crystal elastomers or elastomers with a liquid crystal additive which have nematic or smectic mesophases can exhibit a mesogenic reorientation and inclination as a function of the electric field. Suitable polymer materials are for example polymers based on siloxane, acrylate or methylene ether with liquid crystal side chains or chain-like polymers with a liquid crystal additive of low molecular weight. With monodomains of suitable size (preferably corresponding to the cross section of the projection, e.g. in the range from 10 nm³ to a few μm³), a chain reorientation results in a change in the external geometry of the polymer material. Advantageously, this process is reversible and can be activated and controlled by the strength and/or direction of the electric field.

### 6.2 Self-Organizing Polymer Layers

As shown in FIGS. 7A to 7D, the adhesion of the structured surface 11 can be adjusted by means of a polymer material which is designed to spontaneously form a structured surface as a function of an external electric field (self-organizing polymer material). Suitable polymer materials are described for example by T. Thurn-Albrecht et al. in “Macromolecules”, vol. 33, 2000, pages 3250-3253.

### 7. Radiation-Sensitive Polymer Materials

The variation of the projections of a structured surface may comprise a radiation-induced, in particular light-induced geometric variation of the structure of an elastomer or of a liquid crystal elastomer or of a polymer containing a radiation-sensitive additive. As a result of the irradiation, chemical or physical properties of the polymer material can be varied. Such variations include for example an activation or release of light-sensitive, crosslinking molecules in the polymer material, a changing of dipole moments, conformation changes, changes in the intermolecular interactions or chemical reactions (e.g. crosslinking). As a result of the irradiation, the geometry of the projections may change for example by a shrinkage/expansion, a bending or a twisting.

### 7.1 Polymers Containing Photoisomers

A variation of projections of the structured surface may comprise an isomerization. By way of example, conformation changes of photoisomerizable crosslinking units can be induced by an irradiation. The irradiation takes place at a wavelength which is selected as a function of the absorption behavior of the polymer, for example in the UV, VIS or IR range. A cis-trans photoisomerization of azobenzene by an irradiation at 365 nm or 436 nm may be provided for example. The isomerization process causes a reduction in length of polymer chains. By way of example, a length reduction of the chains from 0.9 nm to 0.55 nm takes place in the azobenzene unit. Alternatively, conformation changes in spirooxazines or chromenes may be provided. As a result of the change in conformation, crosslinking between chains takes place, as a result of which an expansion or shrinkage of the polymer can be induced as a function of the irradiation.

### 7.2 Polymer Materials Containing Photodimers

In a manner analogous to 7.1, a shrinkage can be triggered by a radiation-induced dimerization. By way of example, in a polymer which contains cinnamic groups which form part of the polymer chain, an irradiation may induce a dimerization or crosslinking.

7.3 Polymers with Light-Induced Charge Generation

The projections of the structured surface may be formed by a polymer material which contains an additive designed for charge separation when irradiated. The additive comprises for example triphenylmethane leuco derivatives which dissociate into ion pairs when irradiated with UV light. The irradiation-induced charges may lead to an electrostatic repulsion in the projections, which causes a macroscopic expansion or shrinkage of the material. Accordingly, the shape or orientation of the projections (see e.g. FIG. 1A, 1B or 3A to 3E) can be varied by an irradiation and accordingly the adhesion of the structured surface according to the invention can be adjusted.

7.4 Polymers with Shape Memory

According to a further variant, the projections of the structured surface may be formed of polymers with light-induced shape memory, as described for example by A. Lendlein et al. in “Nature”, vol. 434, 2005, pages 879-882, or in “Adv. Mat.”, vol. 18, 2006, pages 1471-1475.

8. Polymer Materials with Variable Elasticity

The adhesion of the structured surface can be modulated by varying the Young's modulus of the material of the projections and/or of the carrier layer. By varying the elasticity, it is possible to set a required adhesion. The adhesion increases with the softness of the material of the projections and/or of the carrier layer. The Young's modulus may be varied (increased or reduced) for example by a change in temperature or the presence of a chemical substance, such as for example a solvent or water. By the presence of a solvent or moisture in the air, it is possible for example to vary the Young's modulus of hygroscopic polymers or gels, e.g. polyacrylamide or polyether (FIGS. 5A and 5B).

9. Polymer Materials with Variable Surface Energy

Due to the presence of solvents or water or due to a change in temperature, it is possible to vary the physical or chemical properties of polymers with a variable surface energy, such as for example phase-separated polymers (block polymers, polymer blends). Polymer chains located at the surface of the material are varied in the event of a change in the phase compatibility of these polymers as a function of the temperature, a solvent or water. As a result, the adhesion of the surface can be increased or reduced. These changes can be combined with mechanical changes, for example by varying the microstructure of the polymer material.

### APPLICATIONS

FIG. 8 illustrates by way of example an application in transport technology. A component 10 with a structured surface 11 is arranged at a transport tool 20. The transport tool 20 is equipped with a switching device 22, by means of which physical and/or chemical variations of the structured surface 11 can be brought about. By means of the transport device 20, objects such as workpieces 31 for example can be transported from a first workstation 32 to a second workstation 33.

The transport process comprises for example the following steps. Firstly the transport tool 20 is moved to the first workstation 32. By means of the switching device 22, an increased adhesion of the structured surface 11 is set. The component 10 is moved towards the object 31 until the contact area of the structured surface 11 makes contact with the surface of the object 31. Due to molecular interaction forces, an attachment bond is produced between the structured surface 11 and the object 31. By means of the transport tool 20, the object 31 is moved to the second workstation 33. At the latter, the switching device 22 is actuated so that the reduced adhesion of the structured surface 11 is set. As a result, the object 31 is released. The transport tool 20 can be moved back to the first workstation for further method steps.

Corresponding applications are possible e.g. in construction technology, medical technology and in household equipment technology.

The features which are disclosed in the above description, the drawings and the claims may be important both individually and in combination for implementing in its various embodiments.

1-21. (canceled)

22. A structured surface of a solid body, comprising:
a multiplicity of projections, which form a contact area which provides an adhesion capability relative to adjacent surroundings, and
a carrier layer, on which the projections are arranged, wherein
properties of the projections and/or of the carrier layer are specifically variable in such a way that the adhesion of the contact area is adjustable.

23. The structured surface according to claim 22, in which the adhesion of the contact area is adjustable by varying at least one of the physical properties which include an angle of inclination of the projections, a distribution of angles of inclination of the projections, a distance between head parts of the projections, a modulus of elasticity of the projections, a direction-dependence of a modulus of elasticity of the projections and a degree of shrinkage of the carrier layer.

24. The structured surface according to claim 22, in which the adhesion of the contact area is adjustable by varying at least one of the chemical properties which include a molecular structure, a polymer structure, a chemical composition and a surface adsorption of the material of the projections.

25. The structured surface according to claim 22, in which the projections and/or the carrier layer are formed of a material which is variable by a change in temperature, a magnetic field, an electric field, electromagnetic radiation, a mechanical force effect and/or chemical substances.

26. The structured surface according to claim 22, in which the projections or the carrier layer are formed of a polymer material or a metal.

27. The structured surface according to claim 26, in which the polymer material comprises at least one of a shape memory polymer, a liquid crystal polymer, a polymer composite containing metallic, non-magnetic particles, a polymer composite containing magnetic particles, a radiation-sensitive polymer and a liquid-sensitive polymer.

28. The structured surface according to claim 22, in which the properties of the projections and/or the carrier layer are variable reversibly and repeatedly.

29. The structured surface according to claim 22, in which the properties of the projections and/or the carrier layer are variable irreversibly.

30. The structured surface according to claim 22, in which the projections have end faces which in an attachable state of the contact area are at an equal vertical distance from the carrier layer.

31. The structured surface according to claim 22, in which the projections have a hollow or cupped structure which in an attachable state of the contact area forms a suction effect.

32. The structured surface according to claim 22, in which the adhesion of the contact area forms a gradient.

33. The structured surface according to claim 22 which is provided on a structural component.

34. The structured surface according to claim 33, in which the carrier layer of the structured surface forms an integral part of a base body of the component or is arranged in layer form on the base body.

35. A method of using a structured surface according to claim 22, comprising the step of adjusting the adhesion of a component in transport technology, in construction technology, in medical technology, in textile technology, in sports equipment technology, or in household equipment technology.

36. A method for modifying a structured surface of a solid body which comprises a multiplicity of projections, which form a contact area which provides adhesion capability relative to adjacent surroundings, and a carrier layer, on which the projections are arranged, comprising the step of:
targeting varying properties of the projections and/or of the carrier layer in such a way that a predefined adhesion of the contact area is set.

37. The method according to claim 36, in which there is provided a specific variation of at least one of the physical properties which include an angle of inclination of the projections, a distribution of angles of inclination of the projections, a distance between head parts of the projections, a modulus of elasticity of the projections, a direction-dependence of a modulus of elasticity of the projections and a degree of shrinkage of the carrier layer.

38. The method according to claim 36, in which there is provided a specific variation of at least one of the chemical properties which include a molecular structure, a polymer structure, a chemical composition and a surface adsorption of the material of the projections.

39. The method according to claim 36, in which the projections and/or the carrier layer are exposed to a change in temperature, a magnetic field, an electric field, electromagnetic radiation, a mechanical force effect and/or a chemical substance.

40. The method according to claim 36, in which the variation of the properties of the projections and/or of the carrier layer is reversible and is carried out repeatedly.

41. The method according to claim 36, in which the variation of the properties of at least one of the projections and the carrier layer is irreversible.

42. The method according to claim 36, in which a setting of a gradient of the adhesion of the contact area is provided.
